(19) United States
(12) Patent Application Publication
(10) Pub. No.: US 2024/0410648 A1
(43) Pub. Date: Dec. 12, 2024

(54) PURGING SYSTEM AND METHOD FOR BOIL-OFF GAS RELIQUEFACTION APPARATUS FOR SHIP

(71) Applicant: HANWHA OCEAN CO., LTD., Geoje-si, Gyeongsangnam-do (KR)

(72) Inventors: Zie Hyun Kim, Yongin-si, Gyeonggi-do (KR); Seon Jin Kim, Siheung-si, Gyeonggi-do (KR); Won Jae Choi, Siheung-si, Gyeonggi-do (KR)

(21) Appl. No.: 18/702,724

(22) PCT Filed: Dec. 27, 2021
(86) PCT No.: PCT/KR2021/019907

§ 371 Date: Apr. 18, 2024

(30) Foreign Application Priority Data
Nov. 3, 2021 (KR) 10-2021-0149454

(51) Int. Cl. F25J 1/02; F25J 1/00

(52) U.S. Cl. CPC F25J 1/0244; F25J 1/0025; F25J 1/0072; F25J 1/0204; F25J 2290/72

(57) ABSTRACT

A purging system and a purging method for a boil-off gas reliquefaction apparatus for ships are disclosed. The purging system includes: a storage tank disposed in a ship to store a low-temperature liquefied gas and provided with an insulating portion including a vacuum insulation layer; a compressor compressing boil-off gas generated from the storage tank; a heat exchanger in which the compressed gas compressed in the compressor is cooled; and a refrigerant circulation line in which a refrigerant to be subjected to heat exchange with the compressed gas in the heat exchanger circulates, wherein, upon N₂ purging of the reliquefaction apparatus, the purging system supplies N₂ after suctioning and venting a gas from the refrigerant circulation line using a vacuum pump provided to maintain an internal vacuum state of the vacuum insulation layer of the storage tank.

### TECHNICAL FIELD

The present invention relates to a purging system and method for a reliquefaction apparatus for ships, and more particularly to a purging system and method for a reliquefaction apparatus for ships, in which N₂ purging is carried out after a gas in a refrigerant circulation line is suctioned and vented by a vacuum pump provided to maintain an internal vacuum state of a vacuum insulation layer of a storage tank upon purging of the reliquefaction apparatus.

### BACKGROUND ART

Natural gas contains methane as a main component and has been attracting attention as an eco-friendly fuel that emits little or no environmental pollutants during combustion. Liquefied natural gas (LNG) is obtained by liquefying natural gas through cooling to about −163° C. under normal pressure and is suited to long-distance transportation by sea since it has a volume of about 1/600 that of natural gas in a gaseous state. Accordingly, natural gas is stored and transported as liquefied natural gas, which is easy to store and transport.

Since natural gas is liquefied at a cryogenic temperature of −163° C. under normal pressure, LNG storage tanks are typically insulated to maintain LNG in a liquid state. However, despite being insulated, such a storage tank is limited in ability to block external heat. Accordingly, due to external heat continuously transferred to the LNG storage tank, LNG stored in the LNG tank continues to evaporate naturally during transportation, causing generation of boil-off gas (BOG).

Continuous production of boil-off gas in the LNG storage tank increases the internal pressure of the LNG storage tank. If the internal pressure of the storage tank exceeds a predetermined safe pressure, this can cause an emergency situation such as rupture of the storage tank. Accordingly, there is a need to discharge boil-off gas from the storage tank using a safety valve. However, boil-off gas is a kind of LNG loss and is an important issue for transportation efficiency and fuel efficiency of LNG. Therefore, various methods are employed to handle boil-off gas generated in the LNG storage tank.

Recently, a method of using boil-off gas at a fuel demand site such as an engine of a ship, a method of reliquefying boil-off gas and returning the reliquefied boil-off gas to an LNG storage tank, and a method combining these two approaches have been developed and put into use.

### DISCLOSURE

### Technical Tasks

In a reliquefaction cycle for reliquefaction of boil-off gas generated in a ship, typical available liquefaction methods include a process using a single mixed refrigerant (SMR) cycle and a process using a propane-precooled mixed refrigerant (C3MR) cycle. The C3MR cycle is a process in which natural gas is cooled using propane refrigerant alone and then is liquefied and subcooled using a mixed refrigerant, while the SMR cycle is a process in which natural gas is liquefied using a mixed refrigerant composed of multiple components.

As such, the SMR cycle and the C3MR cycle both use a mixed refrigerant. However, if the composition of the mixed refrigerant changes due to refrigerant loss during liquefaction of boil-off gas, this can lead to poor liquefaction efficiency. Accordingly, there is a need to maintain constant composition of the refrigerant by continuously measuring the composition of the mixed refrigerant and replenishing lacking refrigerant components.

An alternative reliquefaction cycle to reliquefy boil-off gas is a single-cycle liquefaction process using nitrogen refrigerant.

Despite relative inefficiency compared to a reliquefaction cycle using a mixed refrigerant, such a reliquefaction cycle using nitrogen refrigerant is safer due to inert properties of nitrogen refrigerant and is easier to apply to ships since nitrogen refrigerant does not undergo phase change.

All equipment and piping in a ship are subjected to N₂ purging immediately after fabrication or before initial start-up after equipment maintenance to reduce an oxygen concentration in the equipment and piping while preventing moisture in air from condensing at low temperature.

In particular, in a reliquefaction cycle that uses nitrogen refrigerant to treat boil-off gas generated from LNG in a cryogenic state, if moisture remaining in equipment and piping is condensed and freezes, there can be damage to main equipment including a heat exchanger, measurement instruments, and piping. Thus, it is very important for the reliquefaction cycle to adjust the dew point.

Conventionally, purging operation is performed by repeating a process of checking the dew point several times to meet the N₂ dew point after the purging operation. However, this method has problems in that, if the volume of the equipment and piping constituting the reliquefaction cycle is large, the N₂ purging flow rate for adjusting the N₂ dew point becomes large and performance time is long.

It is an aspect of the present invention to provide a system and method enabling a rapid reliquefaction cycle by reducing nitrogen consumption for N₂ purging while reducing a time for purging operation.

### Technical Solutions

In accordance with one aspect of the present invention, there is provided a purging system of a boil-off gas reliquefaction apparatus for ships, the purging system including: a storage tank disposed in a ship to store a low-temperature liquefied gas and provided with an insulating portion including a vacuum insulation layer;
a compressor compressing boil-off gas generated from the storage tank;
a heat exchanger in which the compressed gas compressed in the compressor is cooled; and
a refrigerant circulation line in which a refrigerant to be subjected to heat exchange with the compressed gas in the heat exchanger circulates,
wherein, upon N₂ purging of the reliquefaction apparatus, the purging system supplies N₂ after suctioning and venting a gas from the refrigerant circulation line using a vacuum pump provided to maintain an internal vacuum state of the vacuum insulation layer of the storage tank.

Preferably, the refrigerant circulation line includes: a refrigerant expander expanding and cooling a refrigerant to be supplied to the heat exchanger; and a refrigerant compressor compressing the refrigerant discharged after heat exchange in the heat exchanger, the refrigerant circulating in the refrigerant circulation line is nitrogen, and the refrigerant compressor is driven by receiving expansion energy of the refrigerant in the refrigerant expander.

Preferably, the purging system further includes: a hard pipe extending from the vacuum pump to the reliquefaction apparatus; and a flexible pipe connecting the hard pipe to pipes and each device of the reliquefaction apparatus.

Preferably, N₂ purging of the reliquefaction apparatus includes: 1) a vacuuming step in which a gas in the piping and device of the reliquefaction apparatus is suctioned and vented by the vacuum pump; 2) a purging step in which nitrogen is supplied to and vented from the piping and device; and 3) a checking step in which a dew point in the piping and device is checked.

Preferably, step 3) is performed after step 1) and step 2) are sequentially performed twice or more, and when the dew point has not dropped to a preset value in step 3), N₂ purging is returned to step 1), followed by sequentially performing steps 1) to 3).

Preferably, step 1) is carried out for 1 hour by operating the vacuum pump at a vacuum pressure of about 7 mbara, and in step 2), the pipes and devices are purged by supplying and venting nitrogen until an internal pressure reaches about 5 barg.

In accordance with another aspect of the present invention, there is provided a purging method of a boil-off gas reliquefaction apparatus for ships, in which boil-off gas generated from a low-temperature liquefied gas stored in an on-board storage tank is compressed in a compressor and is cooled and reliquefied through heat exchange in a heat exchanger with a refrigerant circulating along a refrigerant circulation line,
wherein the storage tank is provided with an insulating portion including a vacuum insulation layer to keep the low-temperature liquefied gas in a cold state, and
wherein, upon N₂ purging of the reliquefaction apparatus, N₂ is supplied after suctioning and venting a gas from the refrigerant circulation line using a vacuum pump provided to maintain an internal vacuum state of the vacuum insulation layer of the storage tank.

Preferably, N₂ purging of the reliquefaction apparatus includes: 1) a vacuuming step in which a gas in the piping and device of the reliquefaction apparatus is suctioned and vented by the vacuum pump; 2) a purging step in which nitrogen is supplied to and vented from the piping and device; and 3) a checking step in which a dew point in the piping and device is checked.

Preferably, step 3) is performed after step 1) and step 2) are sequentially performed twice or more, and when the dew point has not dropped to a preset value in step 3), N₂ purging is returned to step 1), followed by sequentially performing steps 1) to 3).

Preferably, the vacuuming step is performed by connecting a hard pipe from the vacuum pump to the reliquefaction apparatus; and connecting the hard pipe to the pipes and devices of the reliquefaction apparatus with a flexible pipe.

### Advantageous Effects

In the present invention, upon purging of a reliquefaction apparatus, purging is performed by supplying N₂ after suctioning and venting a gas from piping and each device of the reliquefaction apparatus using a vacuum pump provided for evacuating a vacuum insulation layer of a storage tank.

By evacuating pipes and devices of the reliquefaction apparatus using an on-board vacuum pump prior to N₂ purging, the amount of nitrogen required for N₂ purging and meeting of the dew point requirement of the reliquefaction apparatus and the time for N₂ purging can be reduced, thereby enabling rapid start-up of the reliquefaction apparatus.

In particular, in a reliquefaction apparatus that uses cryogenic nitrogen refrigerant to treat boil-off gas generated from LNG, the purging system and method according to the present invention can prevent damage to main equipment, measurement instruments, and piping of the reliquefaction apparatus due to condensation and freezing of moisture remaining in piping and devices of the reliquefaction apparatus.

### DESCRIPTION OF DRAWINGS

FIG. 1 is a schematic block diagram of a boil-off gas reliquefaction apparatus for ships to which a purging system according to the present invention can be applied.

### EMBODIMENTS

In order to fully appreciate the operational advantages of the present invention and the objectives achieved by practicing the present invention, reference should be made to the accompanying drawings, which illustrate preferred embodiments of the present invention, and description thereof.

Hereinafter, exemplary embodiments of the present invention will be described in detail in terms of the features and effects thereof with reference to the accompanying drawings. It should be noted that like components will be denoted by like reference numerals throughout the specification and the accompanying drawings.

As used herein, the term “ship” may refer to any type of ship that is provided with a liquefied gas storage tank. For example, the ship may include self-propelled vessels, such as an LNG carrier, a liquid hydrogen carrier, and an LNG regasification vessel (RV), as well as non-self-propelled floating offshore structures, such as an LNG floating production storage and offloading (FPSO) unit and an LNG floating storage regasification unit (FSRU).

In addition, the embodiments of the present invention may be applied to a reliquefaction cycle for any type of liquefied gas that can be transported in a liquid state by liquefaction at cryogenic temperatures and can generate boil-off gas during storage. For example, such liquefied gas may include liquefied petrochemical gas, such as liquefied natural gas (LNG), liquefied ethane gas (LEG), liquefied petroleum gas (LPG), liquefied ethylene gas, and liquefied propylene gas. In the following embodiments, the present invention will be described using LNG, which is a typical liquefied gas, as an example.

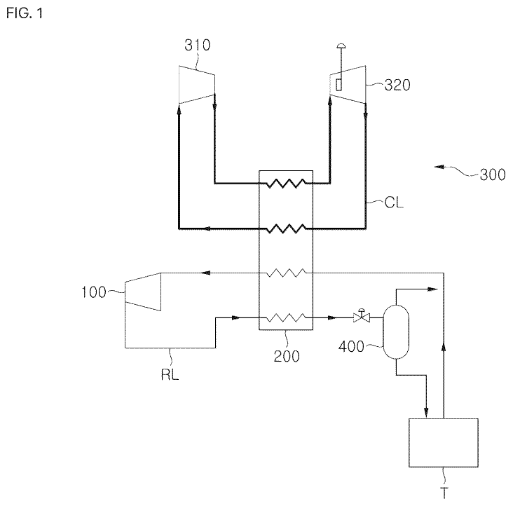

FIG. 1 is a schematic block diagram of a boil-off gas reliquefaction apparatus for ships to which a purging system according to the present invention can be applied.

Referring to FIG. 1, the boil-off gas reliquefaction apparatus includes a compressor 100 that receives and compresses boil-off gas from an on-board storage tank T, a heat exchanger 200 in which the compressed gas compressed by the compressor is cooled, and a refrigerant circulation part 300 in which a refrigerant to be subjected to heat exchange with the compressed gas in the heat exchanger is circulated.

Boil-off gas generated from a low-temperature liquefied gas stored in the storage tank T is supplied to the compressor 100 through the heat exchanger after recovery of cold heat in the heat exchanger. The compressor 100 compresses the boil-off gas to, for example, a fuel supply pressure required for a main engine of the ship. For example, the compressor may compress the boil-off gas to a pressure of 5.5 barg for a DF engine, 15 barg for an X-DF engine, and 300 barg for an ME-GI engine. The compressed boil-off gas may be supplied as fuel to the main engine (not shown) of the ship and surplus compressed boil-off gas may be reliquefied.

Classification societies require that the compressor supplying fuel to an engine be designed with redundancy in case of emergency. Accordingly, although one compressor is shown in FIG. 1, the compressor may include a main compressor and a redundant compressor.

A reliquefaction line RL is connected to a downstream side of the compressor to reliquefy the boil-off gas and return the reliquefied boil-off gas to the storage tank (T). The boil-off gas compressed in the compressor is introduced into the heat exchanger 200 along the reliquefaction line RL and is cooled through heat exchange.

A gas-liquid separator is disposed downstream of the heat exchanger along the re-liquefaction line RL to separate the reliquefied gas into a gaseous phase and a liquid phase. As needed, a decompression valve may be further disposed upstream of the gas-liquid separator in the re-liquefaction line to depressurize the compressed gas cooled in the heat exchanger and to adjust the reliquefaction amount.

The reliquefied gas separated by the gas-liquid separator 400 may be supplied to a storage tank to be stored again and flash gas may be supplied to a stream of uncompressed boil-off gas upstream of the heat exchanger in a boil-off gas supply line or may be delivered to a GCU.

In the refrigerant circulation part 300, a refrigerant circulates along the refrigerant circulation line CL and cools the compressed gas through heat exchange in the heat exchanger 200.

The refrigerant circulation part 300 includes a refrigerant expander 320 in which a refrigerant to be supplied to the heat exchanger is expanded and cooled, and a refrigerant compressor 310 connected to the refrigerant expander to receive expansion energy of the refrigerant and to compress the refrigerant discharged from the heat exchanger after heat exchange in the heat exchanger. A motor (not shown) may be provided to drive the refrigerant compressor, and the refrigerant compressor and the refrigerant expander may be coaxially connected to compress the refrigerant using the expansion energy of the refrigerant, thereby reducing power for driving the refrigerant cycle.

The refrigerant that has been expanded and cooled in the refrigerant expander 320 is introduced into the heat exchanger 200 to provide cold heat, and the refrigerant discharged from the heat exchanger after heat exchange in the heat exchanger is compressed in the refrigerant compressor 310. The refrigerant compressed in the refrigerant compressor 310 is cooled through the heat exchanger 200 and supplied to the refrigerant expander 320 to be expanded and cooled, and is then supplied again to the heat exchanger 200, thereby circulating along the refrigerant circulation line CL.

Accordingly, in the heat exchanger 200, four streams of the boil-off gas compressed in the compressor, uncompressed boil-off gas to be introduced into the compressor, the refrigerant expanded and cooled in the refrigerant expander, and the refrigerant compressed in the refrigerant compressor undergo heat exchange, in which the compressed gas compressed in the compressor and the refrigerant compressed in the refrigerant compressor are cooled by heat exchange with the uncompressed boil-off gas to be introduced into the compressor and the refrigerant expanded and cooled in the refrigerant expander.

Each of pipes and devices of such a reliquefaction apparatus is subjected to N₂ purging after fabrication or prior to initial start-up after equipment maintenance to reduce a concentration of oxygen in the pipes and devices and to prevent moisture in air from condensing at lower temperature.

The purging system according to this embodiment is adapted to allow N₂ purging of such a reliquefaction apparatus.

The present embodiment proposes use of a vacuum pump, which is provided to maintain an internal vacuum state of the vacuum insulation layer of the storage tank, upon N₂ purging of the reliquefaction apparatus.

A storage tank storing low-temperature liquefied gases, particularly cryogenic LNG, is provided with an insulating portion to keep the liquefied gas in a cold state and prevent intrusion of external heat, and the insulation may include a vacuum insulation layer.

To maintain the internal vacuum state of the vacuum insulation layer, a vacuum pump operated at a vacuum pressure is disposed in the ship.

Since the vacuum pump is not always in operation, the vacuum pump is utilized to purge the reliquefaction apparatus, in this embodiment. That is, prior to N₂ purging, the vacuum pump suctions and vents a gas from each device and pipes including the refrigerant circulation line of the reliquefaction apparatus to evacuate the pipes and devices of the reliquefaction apparatus, and then supplies N₂ for purging. As a result, it is possible to reduce the amount of nitrogen for N₂ purging of the reliquefaction apparatus by satisfying requirement for the N₂ dew point and to reduce a time for N₂ purging.

The purging system according to this embodiment may perform purging of the reliquefaction apparatus as follows.

A hard pipe extends from the vacuum pump to a place where the reliquefaction apparatus is installed to connect the vacuum pump to the reliquefaction apparatus and is connected to the pipes and devices of the reliquefaction apparatus by a flexible pipe when purging of the pipes and equipment of the reliquefaction apparatus is required.

N₂ purging of the reliquefaction apparatus may be performed by: 1) a vacuuming step in which a gas in the pipes and devices of the reliquefaction apparatus is suctioned and vented by the vacuum pump after connection of the flexible pipe; 2) a purging step in which nitrogen is supplied to and vented from the pipes and devices of the reliquefaction apparatus; and 3) a checking step in which a dew point in the pipes and devices is checked.

Step 1) is carried out for 1 hour by operating the vacuum pump at a vacuum pressure of about 7 mbara, and in step 2), the pipes and devices are purged by supplying and venting nitrogen until an internal pressure reaches about 5 barg.

Prior to the vacuuming step, it is checked whether each of the devices, pipes and instruments of the reliquefaction apparatus can withstand the vacuum pressure, and the purging system according to this embodiment may be applied upon determining that the devices, pipes and instruments of the reliquefaction apparatus can withstand the vacuum pressure.

After sequentially performing steps 1) and 2) twice or more, it is checked whether the N₂ dew point in the pipes and devices has dropped to a preset level.

When the dew point has not dropped to the preset level, the purging process returns to step 1) to sequentially perform steps 1) to 3).

As described above, the pipes and devices of the reliquefaction apparatus are evaluated by the on-board vacuum pump prior to N₂ purging to reduce the amount of nitrogen required for N₂ purging of the reliquefaction apparatus and to reduce the time for N₂ purging until the preset dew point is achieved, thereby enabling rapid start-up of the reliquefaction apparatus.

In particular, preinstalled on-board equipment is used without installation of additional devices, thereby achieving reduction in installation costs while improving equipment utilization.

Furthermore, in the reliquefaction apparatus that uses cryogenic nitrogen refrigerant to treat boil-off gas generated from LNG, the purging system and method according to the present invention can prevent damage to main equipment, measurement instruments, and piping of the reliquefaction apparatus due to condensation and freezing of moisture remaining in devices and piping of the reliquefaction apparatus.

Although some embodiments have been described herein, it will be apparent to a person having ordinary knowledge in the art that the present invention is not limited thereto and may be implemented through various modifications or variations without departing from the technical spirit of the present invention.

1. A purging system of a boil-off gas reliquefaction apparatus for ships, the purging system comprising:
a storage tank disposed in a ship to store a low-temperature liquefied gas and provided with an insulating portion including a vacuum insulation layer;
a compressor compressing boil-off gas generated from the storage tank;
a heat exchanger in which the compressed gas compressed in the compressor is cooled; and
a refrigerant circulation line in which a refrigerant to be subjected to heat exchange with the compressed gas in the heat exchanger circulates,
wherein, upon N₂ purging of the reliquefaction apparatus, the purging system supplies N₂ after suctioning and venting a gas from the refrigerant circulation line using a vacuum pump provided to maintain an internal vacuum state of the vacuum insulation layer of the storage tank.

2. The purging system according to claim 1, wherein the refrigerant circulation line comprises:
a refrigerant expander expanding and cooling a refrigerant to be supplied to the heat exchanger; and
a refrigerant compressor compressing the refrigerant discharged after heat exchange in the heat exchanger,
the refrigerant circulating in the refrigerant circulation line is nitrogen, and
the refrigerant compressor is driven by receiving expansion energy of the refrigerant in the refrigerant expander.

3. The purging system according to claim 2, further comprising:
a hard pipe extending from the vacuum pump to the reliquefaction apparatus; and
a flexible pipe connecting the hard pipe to pipes and each device of the reliquefaction apparatus.

4. The purging system according to claim 3, wherein N₂ purging of the reliquefaction apparatus comprises:
1) a vacuuming step in which a gas in the pipes and devices of the reliquefaction apparatus is suctioned and vented by the vacuum pump;
2) a purging step in which nitrogen is supplied to and vented from the pipes and devices; and
3) a checking step in which a dew point in the pipes and devices is checked.

5. The purging system according to claim 4, wherein step 3) is performed after step 1) and step 2) are sequentially performed twice or more, and when a dew point has not dropped to a preset value in step 3), N₂ purging is returned to step 1), followed by sequentially performing steps 1) to 3).

6. The purging system according to claim 4, wherein step 1) is carried out for 1 hour by operating the vacuum pump at a vacuum pressure of about 7 mbara, and in step 2), the pipes and devices are purged by supplying and venting nitrogen until an internal pressure reaches about 5 barg.

7. A purging method of a boil-off gas reliquefaction apparatus for ships, in which boil-off gas generated from a low-temperature liquefied gas stored in an on-board storage tank is compressed in a compressor and is cooled and reliquefied through heat exchange in a heat exchanger with a refrigerant circulating along a refrigerant circulation line,
wherein the storage tank is provided with an insulating portion including a vacuum insulation layer to keep the low-temperature liquefied gas in a cold state, and
wherein, upon N₂ purging of the reliquefaction apparatus, N₂ is supplied after suctioning and venting a gas from the refrigerant circulation line using a vacuum pump provided to maintain an internal vacuum state of the vacuum insulation layer of the storage tank.

8. The purging method according to claim 7, wherein N₂ purging of the reliquefaction apparatus comprises:
1) a vacuuming step in which a gas in pipes and devices of the reliquefaction apparatus is suctioned and vented by the vacuum pump;
2) a purging step in which nitrogen is supplied to and vented from the pipes and devices; and
3) a checking step in which a dew point in the pipes and devices is checked.

9. The purging method according to claim 8, wherein step 3) is performed after step 1) and step 2) are sequentially performed twice or more, and when a dew point has not dropped to a preset value in step 3), N₂ purging is returned to step 1), followed by sequentially performing steps 1) to 3).

10. The purging method according to claim 8, wherein the vacuuming step is performed by connecting a hard pipe from the vacuum pump to the reliquefaction apparatus; and connecting the hard pipe to the pipes and devices of the reliquefaction apparatus with a flexible pipe.
